(19) United States
(12) Patent Application Publication
(10) Pub. No.: US 2010/0287256 A1
(43) Pub. Date: Nov. 11, 2010

(54) METHOD AND APPARATUS FOR PROVIDING SOCIAL NETWORKING CONTENT

(75) Inventor: Michael Patrick Neilio, Poway, CA (US)

Correspondence Address: DITTHAVONG MORI & STEINER, P.C., 918 Prince Street, Alexandria, VA, 22314, US

(73) Assignee: Nokia Corporation, Espoo (FI)

(21) Appl. No.: 12/435,882

(22) Filed: May 5, 2009

(51) Int. Cl. G06F 17/30; G06F 15/16

(52) U.S. Cl. 709/217; 707/E17.044; 707/E17.009

(57) ABSTRACT

An approach for providing social networking content in a mobile environment is described. A social networking widget on a mobile device extracts content from one or more social networking services according to a bandwidth allocation of a usage plan associated with the mobile device. The social networking widget minimizes bandwidth use by setting limits on a maximum number of social networking members a user can follow, a maximum number of features or feeds a user can follow, and a maximum refresh rate for social networking content.

### BACKGROUND

Wireless (e.g., cellular) service providers and device manufacturers are continually challenged to deliver value and convenience to consumers by, for example, providing compelling network services. One area of development has been in the area of providing social networking services on mobile devices. In particular, developers are challenged to provide a user interface and user experience for social networking services in a mobile environment where the display and bandwidth available to the mobile device are potentially limited.

### SOME EXAMPLE EMBODIMENTS

Therefore, there is a need for an approach for efficiently and conveniently providing social networking content in a mobile environment.

According to one embodiment, a method comprises generating a request, via a widget of a mobile device, for member identifiers of one or more social networking services. The method also comprises receiving the requested member identifiers over a radio network. The method further comprises matching the requested member identifiers with entries of a contact list of the mobile device. The method further comprises initiating, for a subset of member identifiers that match, prompting of a user of the mobile device to select member identifiers from the subset to follow or to synchronize between the one or more social networking services and the contact list. The method further comprises extracting content from the one or more social networking services for the selected member identifiers according to a usage plan of the mobile device, wherein the usage plan specifies a bandwidth allocation for receiving content over the radio network.

According to another embodiment, an apparatus comprising at least one processor, and at least one memory including computer program code, the at least one memory and the computer program code configured to, with the at least one processor, cause the apparatus to generate a request, via a widget of a mobile device, for member identifiers of one or more social networking services. The apparatus is also caused to receive the requested member identifiers over a radio network. The apparatus is further caused to match the requested member identifiers with entries of a contact list of the mobile device. The apparatus is further caused to initiate, for a subset of member identifiers that match, prompting of a user of the mobile device to select member identifiers from the subset to follow or to synchronize between the one or more social networking services and the contact list. The apparatus is further caused to extract content from the one or more social networking services for the selected member identifiers according to a usage plan of the mobile device, wherein the usage plan specifies a bandwidth allocation for receiving content over the radio network.

According to another embodiment, a computer-readable storage medium carrying one or more sequences of one or more instructions which, when executed by one or more processors, cause an apparatus to generate a request, via a widget of a mobile device, for member identifiers of one or more social networking services. The apparatus is also caused to receive the requested member identifiers over a radio network. The apparatus is further caused to match the requested member identifiers with entries of a contact list of the mobile device. The apparatus is further caused to initiate, for a subset of member identifiers that match, prompting of a user of the mobile device to select member identifiers from the subset to follow or to synchronize between the one or more social networking services and the contact list. The apparatus is further caused to extract content from the one or more social networking services for the selected member identifiers according to a usage plan of the mobile device, wherein the usage plan specifies a bandwidth allocation for receiving content over the radio network.

According to another embodiment, an apparatus comprises means for generating a request, via a widget of a mobile device, for member identifiers of one or more social networking services. The apparatus also comprises means for receiving the requested member identifiers over a radio network. The apparatus further comprises means for matching the requested member identifiers with entries of a contact list of the mobile device. The apparatus further comprises means for initiating, for a subset of member identifiers that match, prompting of a user of the mobile device to select member identifiers from the subset to follow or to synchronize between the one or more social networking services and the contact list. The apparatus further comprises means for extracting content from the one or more social networking services for the selected member identifiers according to a usage plan of the mobile device, wherein the usage plan specifies a bandwidth allocation for receiving content over the radio network.

According to another embodiment, a method comprises receiving input from a mobile device over a radio network for selecting content of one or more social networking services. The method also comprises determining one or more matching entries between a contact list of a mobile device with member identifiers of the one or more social networking services. The method further comprises scaling content associated with the one or more social networking services according to the one or more matching entries and a usage plan of the mobile device, wherein the usage plan specifies a bandwidth allocation for receiving content over the radio network.

According to another embodiment, an apparatus comprising at least one processor, and at least one memory including computer program code, the at least one memory and the computer program code configured to, with the at least one processor, cause the apparatus to receive input from a mobile device over a radio network for selecting content of one or more social networking services. The apparatus is also caused to determine one or more matching entries between a contact list of a mobile device with member identifiers of the one or more social networking services. The apparatus is further caused to scale content associated with the one or more social networking services according to the one or more matching entries and a usage plan of the mobile device, wherein the usage plan specifies a bandwidth allocation for receiving content over the radio network.

According to another embodiment, a computer-readable storage medium carrying one or more sequences of one or more instructions which, when executed by one or more processors, cause an apparatus to receive input from a mobile device over a radio network for selecting content of one or more social networking services. The apparatus is also caused to determine one or more matching entries between a contact list of a mobile device with member identifiers of the one or more social networking services. The apparatus is further caused to scale content associated with the one or more social networking services according to the one or more matching entries and a usage plan of the mobile device, wherein the usage plan specifies a bandwidth allocation for receiving content over the radio network.

According to yet another embodiment, an apparatus comprises means for receiving input from a mobile device over a radio network for selecting content of one or more social networking services. The apparatus also comprises means for determining one or more matching entries between a contact list of a mobile device with member identifiers of the one or more social networking services. The apparatus further comprises means for scaling content associated with the one or more social networking services according to the one or more matching entries and a usage plan of the mobile device, wherein the usage plan specifies a bandwidth allocation for receiving content over the radio network.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing social networking content, according to one embodiment;

FIG. 2 is a diagram of the components of a social networking widget, according to one embodiment;

FIG. 3 is a diagram of the data structure of a contact list and the data structure of a member identifiers list of a social networking service utilized in the system of FIG. 1, according to one embodiment;

FIG. 4 is a flowchart of a process for providing social networking content via a social networking widget, according to one embodiment;

FIGS. 5A-5C are flowcharts of processes for minimizing bandwidth usage for social networking content, according to various embodiments;

FIG. 6 is a flowchart of a process for storing and presenting social networking content, according to one embodiment;

FIG. 7 is a flowchart of a process of providing social networking content via a server, according to one embodiment;

FIGS. 8A-8D are diagrams of user interfaces utilized in the processes for providing social networking content, according to various embodiments;

FIG. 9 is a diagram of hardware that can be used to implement an embodiment of the invention;

FIG. 10 is a diagram of a chip set that can be used to implement an embodiment of the invention; and

FIG. 11 is a diagram of a mobile station (e.g., handset) that can be used to implement an embodiment of the invention.

### DESCRIPTION OF PREFERRED EMBODIMENT

A method and apparatus for providing social networking content are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

As used herein, the term “widget” refers to light-weight applications that provide a variety of services and functions on a user device. Although various embodiments are described with respect to widgets, it is contemplated that the approach described herein may be used with other applications including stand-alone applications and web-based applications.

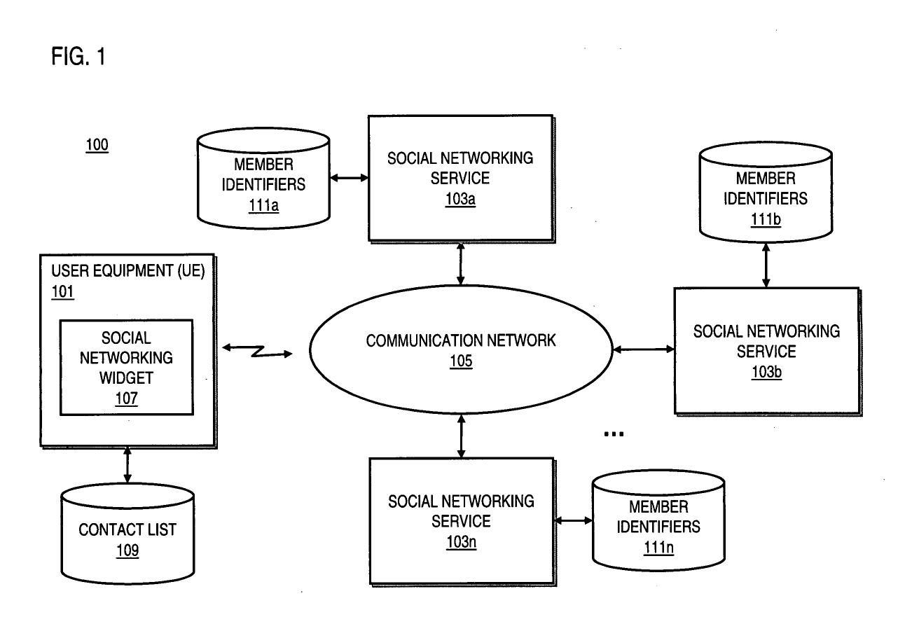

FIG. 1 is a diagram of a system capable of providing social networking content, according to one embodiment. As the use of social networking services becomes increasingly popular, users are discovering that their closest friends are quickly becoming buried among a flood of acquaintances that the users have accepted as friends in one or more social networking services. In essence, many social networking services are becoming archives of acquaintances rather than a community of people with whom users really want to remain connected. For example, a user may accept invitations from all of the user's classmates even though the user actually maintains connection with only three or four of the classmates. As a result, the volume of chatter or feeds from all of the other classmates in the social networking service may obscure the communications from the user's closest friends.

The problem of extraneous feeds is particularly acute in the mobile environment, where both bandwidth and display size are typically more limited than when accessing the social networking service using a desktop or laptop computer. For example, on subscribing to a feed from a member of the social networking service, the device begins to periodically pull information from the feed, and thus using bandwidth for each feed or person the user is following. As the number of friends or feeds grows into the hundreds or even greater, the bandwidth available to a device in a mobile radio environment (e.g., a cellular system) can quickly become saturated, thereby degrading performance for the user by retrieving information that the user may not really want. Also, as information flows in from the subscribed feeds, the small display typical of a mobile device historically cannot easily display all of the information. The user may then find it necessary to scroll to page after page of information to locate information of interest.

From a network service provider's perspective, the transmission of unwanted or extraneous feeds from social networking services to and from its users may cause network capacity issues and also degrade the overall level of service available to users of the service provider's network.

To address this problem, a system 100 of FIG. 1 introduces the capability to selectively filter content retrieved from social networking services when accessing those services from a mobile device. Because the filtering is performed, for instance, at the mobile device, the user need not change settings or alter relationships in the respective social networking services. In this way, the user can still have access to the full unfiltered social networking content when the user accesses the social networking services from a computer or is otherwise in an environment where bandwidth is not restricted. Even when the user has access to the full unfiltered social networking content, the user may nonetheless choose to filter the content using the process described herein so that the information of most interest to the user is more easily accessible. In one embodiment, the system 100 filters social networking content by matching a user's contact list stored, for instance, in the user's mobile device against the user's contacts created in one or more social networking services. The user may then select to receive feeds from matched contacts or a subset of thereof. In addition, the system 100 enables the user to link and view feeds according to the contact list. For instance, selecting an entry in the user's contact list displays all received social networking feeds from that particular contact.

The system 100 also enables setting additional limits on social networking content to minimize bandwidth. For example, based on bandwidth allocation, the service provider or even the user may set limits on the volume of social networking content that the user may access at any time (e.g., a limit on the number of social networking contacts that can be followed at one time, a limit on the number of features or feeds that can be followed, or a maximum refresh rate for social networking content). In this way, the service provider can ensure the availability of bandwidth to service social networking content requests to users of the provider's network.

As shown in FIG. 1, the system 100 comprises a user equipment (UE) 101 having connectivity to a one or more social networking services 103a-103n via a communication network 105. By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), the Internet, or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, mobile ad-hoc network (MANET), and the like.

The UE 101 is any type of mobile terminal, fixed terminal, or portable terminal including a mobile handset, station, unit, device, multimedia tablet, Internet node, communicator, desktop computer, laptop computer, Personal Digital Assistants (PDAs), or any combination thereof. It is also contemplated that the UE 101 can support any type of interface to the user (such as “wearable” circuitry, etc.). In one embodiment, the UE 101 includes a social networking widget 107 (e.g., social networking application) and has connectivity to a database 109 of one or more contact lists. The social networking widget 107, for instance, performs the approach to providing social networking content described herein. It is contemplated that the contact list database 109 may include any number of fields, including, for example, name of contact, telephone number, E-mail address, and other related information fields. Moreover, the contact list may be associated with the UE 101 itself or with one or more applications (not shown) running on the UE 101.

According to one embodiment, the social networking widget 107 can be downloaded at the request of the user, or alternatively, be delivered based on registration to one or more of the social networking services 103a-103n. Generally, a widget can be regarded as a user interface element, and can be support or be software that provides a variety of content information (e.g., social networking content, news stock quotes, weather forecasts, maps, location information, advertisement, calendars, calendar information, contact information, messages, emails, service guide information, recommendations, audio files, video files, radio/television broadcasting, etc. A widget may be configured to continuously receive content information, such as continuously updated content, from one or more sources. In the social networking context, the continuously updated content include presence information, feeds, blogs, photos, music, and the like associated with one or more members of the social networking service.

In certain embodiments, each social networking service 103a-103n has connectivity, respectively, to databases 111a-111n of member identifiers. The member identifiers databases 111a-111n store information on registered members of the respective social networking services 103a-103n. By way of example, the social networking services 103a-103n may be provided by either the operator of the communication network 105 or a third party (not shown). The social networking services 103a-103n, for instance, enables users to form online communities for sharing common interests (e.g., hobbies, work, family, organizations, etc.). A user of a social networking service 103 can use the service 103 to, for instance, form relationships with other members of the service. Historically, there have been a variety of social networking services 103a-103n available to users (e.g., MySpace®, Facebook®, LinkedIn®, etc.) catering to various interests. Accordingly, it is not uncommon for users to belong to multiple social networking services 103a-103n.

Through the UE 101, the social networking widget 107 has access to contact list database 109 as well as to the member identifiers databases 111a-111n of the social networking services 103a-103n. It is contemplated that the communication network 105 may include any number of social networking services 103a-013n. Moreover, although FIG. 1 depicts the social networking widget 107 as an application within the UE 101, it is contemplated that the social networking widget 107 may also be implemented as a stand-alone service on the network side of the communication network 105 (not shown). In addition or alternatively, the contact matching platform may be implemented one or more of the social networking services 103a-103n.

By way of example, the UE 101, the social networking widget 107, and the social networking services 103a-103n communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

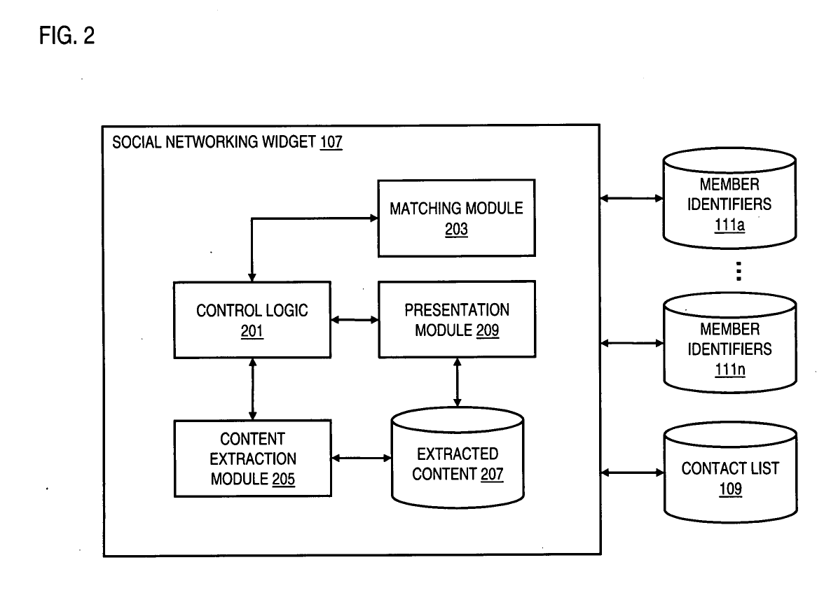

FIG. 2 is a diagram of the components of a social networking widget 107, according to one embodiment. By way of example, the social networking widget 107 includes one or more components for providing social networking content in a mobile environment. It is contemplated that the functions of these components may be combined in one or more components or performed by other components of equivalent functionality. In this embodiment, the social networking widget 107 includes a control logic 201 for directing the filtering and scaling (e.g., changing of what social networking content to transmit to a mobile device) according to, for instance, the bandwidth allocation of a network usage plan (e.g., data plan) associated with a mobile device. For example, the usage plan may specify a maximum available bandwidth or a maximum amount of data that can be transferred over a period of time. Service providers typically make several data plans available to a user (e.g., limited data plans where access is limited by maximum data rate or maximum data amount, or unlimited plans where there is not present maximum data transfer quota). By way of example, the available bandwidth can also be predicted by a usage analysis based on, for example, the number of mobile devices in the radio network or cell, the load of the serving radio base station, and even on the time of the day or week. In one embodiment, only those devices within a predetermined proximity to the user device send status messages or other social networking content to the user device.

The control logic 201 interacts with the matching module 203 to initiate the process of filtering of social networking content by matching entries from the contact list 109 against member identifiers (e.g., alias, user name, user identification, etc. representing a member) of the social networking services 103a-103n contained respectively in databases 111a-111n. The matching can be determined according to predetermined criteria such name, phone number, E-mail address, and location. In certain embodiments, the predetermined criteria may also include more descriptive parameters such as hobbies, interests, characteristics of the contacts as defined in, for instance, the social networking service 103. For example, the matching module 203 retrieves information corresponding to the predetermined matching criteria from the contact list database 109 and the member identifiers databases 111a-111n. To retrieve only those members of the social networking services 103a-103n that are already associated with the user, the matching module 203 may retrieve contacts from the social networking services 103a-103n using, for instance, the user's login credentials (e.g., user name/password) associated with the respective social networking services 103a-103n.

In one embodiment, the matching module 203 determines whether there is a complete match of all predetermined criteria between the one or more entries in the contact list 109 and the respective entries in the member identifiers databases 111a-111n. For example, the matching module 203 determines a complete match if all retrieved information related to the predetermined criteria (e.g., name, phone number, E-mail) between the contact list 109 and the member identifiers databases 111a-111n match. In addition or alternatively, it is contemplated that the matching module 203 can present partial matches or matches in multiple social networking services 103a-103n to the user for confirmation and/or selection. In one embodiment, a partial match includes matching a name based on alternate spellings (e.g., “Thomas Smith” in the contact list database 109 vs. “Tom Smith” in the member identifiers databases 111a-111n). In another embodiment, a partial match may be determined if some, but not all, of the criteria match, e.g., the matching logic may declare a partial match if the name and E-mail address match, but not the phone number. It is contemplated that matching logic 109 can use any parameter or data field included in the contact list database 109 and/or the member identifiers databases 111a-111n to match the entries.

On determination of a match, the matching module 203 can prompt the user to select which members to follow (e.g., which members to retrieve social networking content from) and which members to synchronize between the contact list 109 and the member identifiers databases 111a-111n. For example, synchronization of the an entry between the contact list 109 and a member identifiers database 111 ensures that the information in each database matches and is current with respect to each other. It is contemplated that any or all information of each entry may be synchronized included associated media such as photos, music, and video. If there are unmatched entries (e.g., an entry in the contact list 109 that is not in the member identifiers database 111, or an entry in the member identifiers database 111 that is not in the contact list 109), the matching module 109 can prompt the user to determine whether to copy the entry among the various databases (e.g., contact list 109 and member identifiers database 111a-111n).

Based on the selected members to follow, the control logic 201 interacts with the contact extraction module 205 to extract content from the one or more social networking services 103a-103n related to the selected members. By way of example, the content extraction module 205 requests feeds from the social networking services 103a-103n using both public and private application programming interfaces (APIs) available from the respective providers of the social networking services. Public APIs, for instance, are APIs that have been released to the public and are generally available. In contrast private APIs are proprietary APIs developed by the provider or a third party to facilitate accessing the functions or data of the social networking services 103a-103n. The content extraction module 205 then extracts the information from the feeds using, for instance, HTML parser or XML parser and stores the extracted content in the database 207 of extracted content. In one embodiment, the module 205 extracts the social networking content according to limits based on the allocated bandwidth of the usage plan associated with the mobile device. For example, depending on the bandwidth, the number of members that the social networking widget 107 can follow can be limited. The maximum number of features or feeds from the social networking services 103a-103n can be similarly limited. In addition, the rate at which the content extraction module 205 refreshes the extracted content can also be limited. Generally, when there is more available bandwidth, the maximum number of members to follow and the maximum number of features or feeds to follow is higher. Moreover, the maximum refresh rate of the extracted content can similarly be higher.

After storing the information in the extracted content database 207, the control logic 201 can direct the presentation module 209 to display the stored content in a number of different ways. For example, the presentation module 209 can display the extracted content according to entries in the contact list. More specifically, the social networking content associated with each contact is displayed, for example, under that contact's entry in the contact list. In addition, the presentation module 209 can display the social networking content in chronological order. Moreover, the presentation module 209 can display the extracted social networking content in the social networking widget 107 or other application on the UE 101. It is contemplated that the presentation module 209 may display the social networking content in any format and through any mechanism or application available on the UE 101.

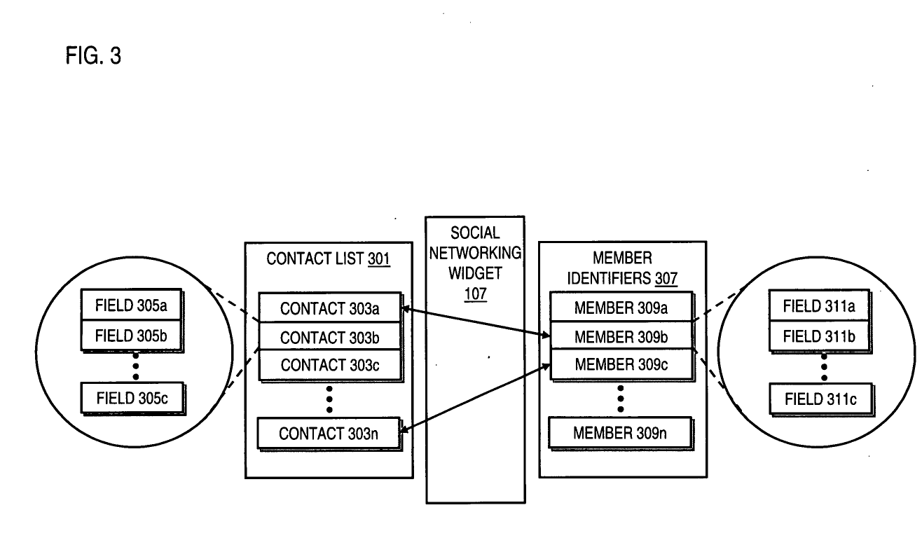

FIG. 3 is a diagram of the data structure of a contact list and the data structure of a member identifiers list of a social networking service utilized in the system of FIG. 1, according to one embodiment. As in typical database management systems, data can be stored in one or more data containers, each container contains records, and the data within each record is organized into one or more data fields. As shown in FIG. 3, a contact list data container 301 corresponds to, for instance, the contact list database 109. The contact list data container 301 includes contact records 303a-303n representing each entry of the contact list. Further, each contact 303 may be broken down into data fields 305a-305n correlating to various parameters that describe a contact (e.g., name, telephone number, E-mail address, hobbies, interests, characteristics). In this regard, the number of data fields 305a-305n, is dependent on the level of detail that the user would like to maintain. Hence, it is possible for two different contact lists to have different data fields.

Similarly, the member identifiers data container 307 corresponds to the member identifiers database 111 of the social networking service 103. The member identifiers data container 307 includes member records 309a-309n correlating to, for instance, each registered member of the social networking service 103. Each member record 309 is further broken down into data fields 31la-311b represent various parameters that describe the member (e.g., name, telephone number, E-mail address, hobbies, interests, characteristics). As described with respect to the contact list data container 301, the number of data fields 311 is dependent on, for instance, the level of detail that the social networking service 103 would like to maintain.

As shown in FIG. 3, the social networking widget 107 provides the logic for matching entries in the contact list data container 301 and their respective entries in the member identifiers data container 307. As described previously, the data fields between the contact list 109 and the member identifiers databases 111a-111n may differ depending on the level of detail desired for the respective list. In addition, different social networking services 103a-103n, as well as the contacts list 109, may name each data field differently even though they might contain the same or similar information. For example, the name field 305a in the contact list data container 301 may be called “NAME” whereas the equivalent data field in the member identifiers data container 307 may be called “FULL NAME.” Accordingly, it is contemplated that the social networking widget 107 includes logic to either automatically or with user input correlate fields between the contact list data container 301 and the member identifiers data container 307 to facilitate matching.

As part of the matching process, the social networking widget 107, for instance, compares records in the contact list data container 301 against records in the member identifiers data container 307 to determine which if any of the records match. As described with respect to FIG. 2, the comparison includes retrieving information from the data fields 305 of the contact list data container 301 and the data fields 311 of the member identifiers data container 307 corresponding to the predetermined criteria chosen for matching (e.g., name, telephone number, E-mail address). As shown, the social networking widget 107 matched contact 303a with member 309b and contact 303n with member 309c.

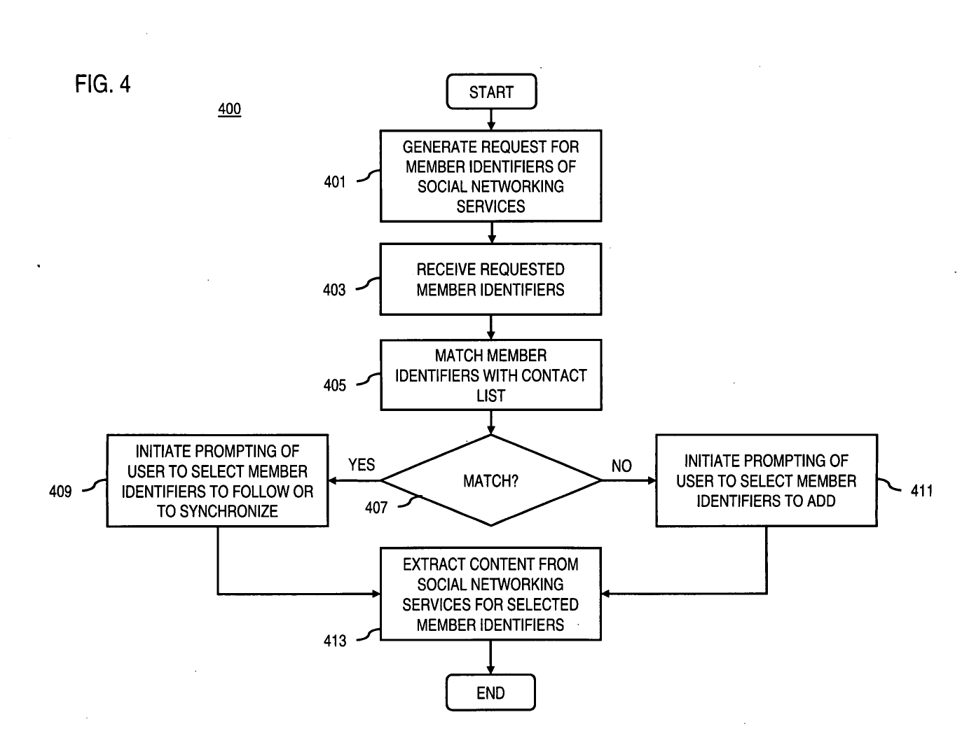

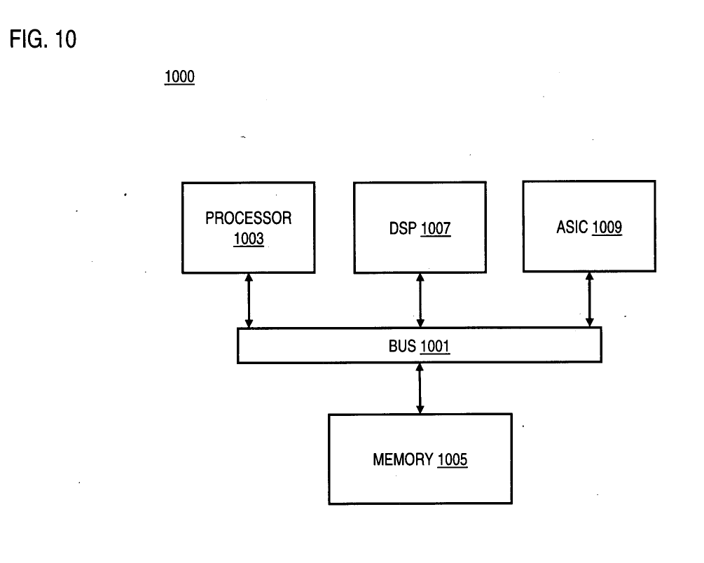

FIG. 4 is a flowchart of a process for providing social networking content via a social networking widget, according to one embodiment. In one embodiment, the social networking widget 107 performs the process 400 and is implemented in, for instance, a chip set including a processor and a memory as shown FIG. 10. In step 401, the social networking widget 107 generates a request for member identifiers of one or more social networking services 103a-103n. As discussed with respect to FIG. 2, the request may include login credentials associated with the user to obtain member identifiers that have already been associated with the user in one or more of the social networking services 103a-103b. The social networking widget 107 then receives the requested member identifiers over a radio network (e.g., a cellular network) from the one or more social networking services 103a-103n (step 403). In other embodiments, the request need not contain the user's login credentials. If no login credentials are provided, the social networking widget 107, for instance, compares the user's contact list 109 with the entire membership (e.g., member identifiers database 111a-111n) of the one or more social networking services 103a-103n.

The social networking widget 107 then matches the retrieved member identifiers with the contact list 109 using, for example, the matching process described with respect to FIG. 2 (step 405). If there are matched entries (step 407), the social networking widget 107 initiates prompting of the user to select member identifiers from the subset of matched entries to follow or to synchronize (step 409). As used herein, the term “to follow” means that the user receives social networking content and feeds related to the member that the user is “following.” If the user chooses to synchronize the matched contacts, the social networking widget will update the respective entries in the contact list 109 and the member identifiers databases 111a-111n with the most current information among the various sources. If there are any synchronization conflicts that cannot be automatically resolved (e.g., conflicting updates performed at the same time), the social networking widget 107 can request input from the user to resolve the conflict. In certain embodiments, the user may also select the data set (e.g., the contact list or the member identifiers databases 111a-111n) that is the definitive set for resolving conflict. In addition, synchronization can include synchronization media and other content associated with the member profile in the social networking services 103a-103n. For instance, the social networking widget 107 can synchronize the picture of the contact in the contact list 109 with one or more of the pictures uploaded to one or more of the social networking services 103a-103n. In one embodiment, the synchronization of media and other content associated with the member profile in the social networking services 103a-103n may be determined by a “mobile active” field. For example, if particular media or content have a corresponding mobile active field set to active, the media or content will be synchronized to a mobile device. If, however, the mobile active field is set to inactive, the media or content is not synchronized to the mobile. In another embodiment, the mobile active field may be set automatically based on the type of connection the mobile device is using. For example, if the mobile device is on a high speed wireless local area network (WLAN) connection, the mobile active field is set to active. If the mobile device is on a limited cellular connection, the mobile active is set to inactive.

For entries that are not matched, the social networking widget 107 can initiate prompting of the user to select to either add the member to the contact list 109 or the entry in the contact list 109 to one or more of the social networking services 103a-103n (step 411). For example, there may be entries in the contact list 109 that are not one or more of the social networking services 109. In this case, the social networking widget 107 can send an invitation to the unmatched contact to join one or more of the social networking services 103a-103n. Once the unmatched contact chooses to join the social networking service 103, the user can either select the member to follow or to synchronize as described with respect to step 409. In one embodiment, the options to follow, synchronize, and/or add a member are not mutually exclusive. That is, the user can perform any of the three actions in any combination.

After selecting the member identifiers to follow, synchronize, and/or add, the social networking widget 107 extracts content from one or more social networking services 103a-103n for the selected member identifiers (step 413). In one embodiment, the extraction of the content is performed according to a usage plan associated with the user's mobile device. For example, the usage plan specifies a bandwidth allocation for receiving content over the radio network. As described previously, service providers typically offer a variety of usage plans for accessing data over a radio network (e.g., a cellular network). Less expensive plans, can charge based on the actual amount of data transferred (e.g., a pay-as-you-go plan where the user is charged per megabyte of data transferred). In another example, the usage plan may limit the data rate or place a cap on the maximum amount of data that can be transferred over a period of time. In yet another example, the usage plan may be an unlimited plan, whereby the user pays a fixed price for unlimited data transfers.

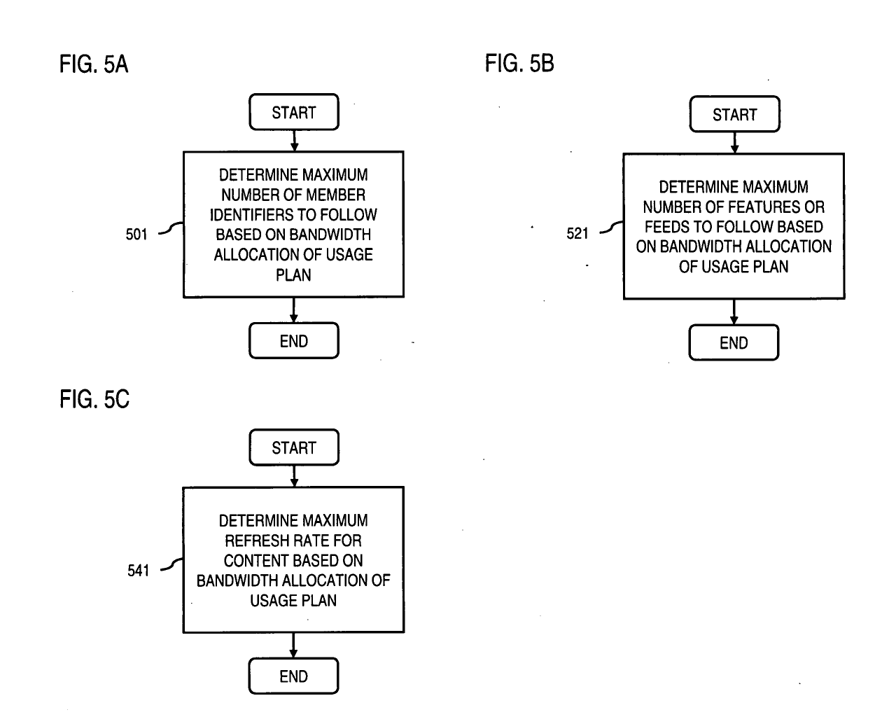

It is noted that a typical social networking widget 107 consumes approximately 100 kB/hour of just. With a typical level of use, the average per month cost may approach $100/month for data alone if the user is one a pay-as-you-go plan. Therefore, if the user is on a limited usage plan, the user may be interested in setting limits on bandwidth use to avoid potentially expensive excess usage charges. The processes for minimizing bandwidth are discussed below with respect to FIGS. 5A-5C.

FIGS. 5A-5C are flowcharts of processes for minimizing bandwidth usage for social networking content, according to various embodiments. In one embodiment, the social networking widget 107 performs the processes of FIGS. 5A-5C and is implemented in, for instance, a chip set including a processor and a memory as shown FIG. 10. FIG. 5A is a flowchart of a process for limiting the number of member identifiers to follow, according to one embodiment. In step 501, the social networking widget determines the maximum number of member identifiers that can be followed based on the bandwidth allocation of the usage plan of the mobile device. For example, for a basic usage plan with a limit of 10 megabytes per month of total data transfer, the social networking widget 107, the user, or the service provider may set the maximum number of member identifiers to follow at three simultaneous members to reduce the potential for the user to exceed the limits of the data plan. If however, the user has an unlimited data plan, the user may be limited only by the maximum bandwidth and the maximum number of member identifiers may be correspondingly higher at 15 member identifiers to follow. The social networking widget 107 then extracts the selected content according to the determined maximum number of member identifiers to follow. By limiting the number of member identifiers to follow in one or more social networking services 103a-103n, the social networking widget 107 also reduces the potential amount of social networking content that has be transferred to the mobile device.

FIG. 5B is a flowchart of a process for limiting the number of feature or feeds to follow, according to one embodiment. This example is similar to the example FIG. 5B with the exception that FIG. 5B limits the maximum number of features or feeds to follow rather than the members of FIG. 5A. Nonetheless, the principle remains the same. In step 521, the social networking widget 107 determines the maximum number of features (e.g., photo downloads) or feeds (e.g., a blog) to follow based on the bandwidth allocation of the usage plan associated with the mobile device. As with respect to FIG. 5A, the social networking widget 107 enforces any limits imposed by the social networking widget 107.

FIG. 5C is a flowchart of a process for limiting the refresh rate for social networking content, according to one embodiment. As discussed previously, the social networking widget 107 periodically re-extracts content from the social networking services 103a-103n to ensure that the widget 107 has the latest available content. In one embodiment, the higher the refresh rate, the more likely the social networking widget 107 will have the latest information at any given time. However, a higher refresh rate also results in higher volumes of data transfers. For example, updating the widget 107 every 6 minutes versus every 60 minutes increases the amount of data transferred over the same period of time by one order of magnitude. Accordingly, in step 541, the social networking widget 107 determines the maximum refresh rate for content based on the bandwidth allocation of the usage plan associated with the mobile device. For example, with a basic plan with limited bandwidth, the maximum refresh rate may be one refresh every 45 minutes. Any higher refresh rate could potentially result in excess data charges with operating under the limited usage plan.

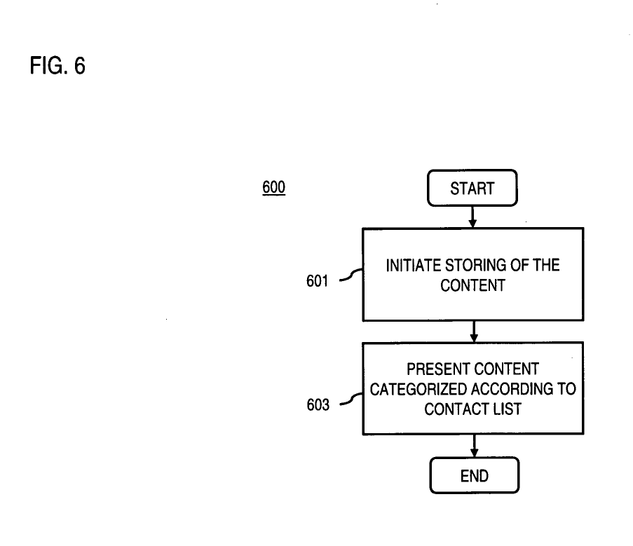

FIG. 6 is a flowchart of a process for storing and presenting social networking content, according to one embodiment. In one embodiment, the social networking widget 107 performs the process 600 and is implemented in, for instance, a chip set including a processor and a memory as shown FIG. 10. It is assumed that the social networking widget 107 has already extracted the selected content is from the one or more social networking services 103a-103b. In step 601, the social networking widget 107 initiates storing of the extracted content in, for instance, the extracted content database 207 resident with the widget 107. By storing the extracted content locally, the social networking widget 107 can decrease the response time for displaying the content at the user's request. In other words, the social networking widget 107 caches the extracted data locally to at least in part avoid the delay caused by having to retrieve the data on demand over the communication network 105. Once the extracted content is stored, the social networking widget 107 can present the stored content according to the contact list 109 of the mobile device (e.g., UE 101) (step 603). In addition or alternatively, the social networking widget 107 can present the extracted content in chronological order or in a display within the widget 107 itself.

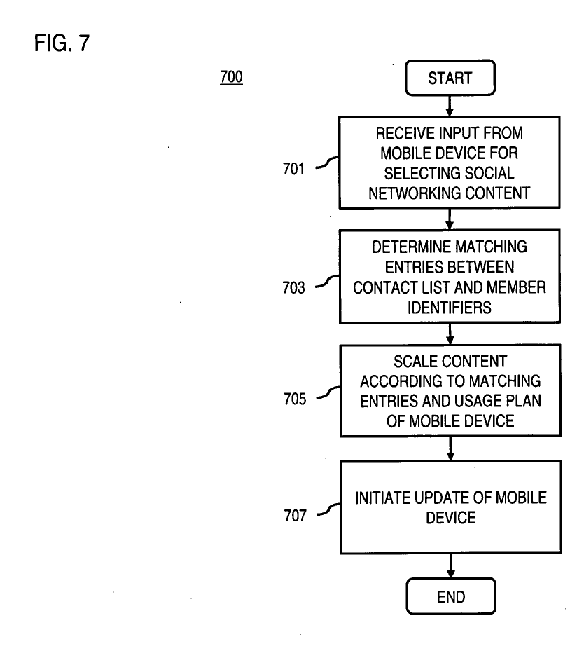

FIG. 7 is a flowchart of a process of providing social networking content via a server, according to one embodiment. In one embodiment, a server (not shown) with connectivity to the communication network 105 performs the process 700 to provide social networking content to, for instance, a mobile device (e.g., UE 101). The server may be operated by the service provider or a third party. In step 701, the server receives input from the mobile device over a radio network (e.g., a cellular network) for selecting content of one or more social networking services. By way of example the content includes one or more feeds associated with one or more members of a social networking service 103a. The server then determines one or more matching entries between a contact list 109 of the mobile device and the member identifiers 111a database associated with the social networking service 103a (step 703). In one embodiment, the matching is performed according to the processes described with respect to FIGS. 2 and 3.

In the next step 705, the server scales the selected social networking content according to the one or more matching entries and the bandwidth allocation of the usage plan associated with the mobile device. For example, the server may set limitations (e.g., maximum number of members to follow, maximum number of features or feeds to follow, maximum refresh rate for the selected content) based on the bandwidth allocations. In other words, if the bandwidth allocation is low, the server will scale the content lower by setting lower limits (e.g., the maximums lists above). After scaling the content, the server initiates update (e.g., transfer) of the content to the mobile device (step 707). In one embodiment, the mobile device stores the scaled content locally and can categorize the content according to one or more entries of the contact list 109 of the mobile device. In this way, the mobile device can present the social networking content organized by the related contact.

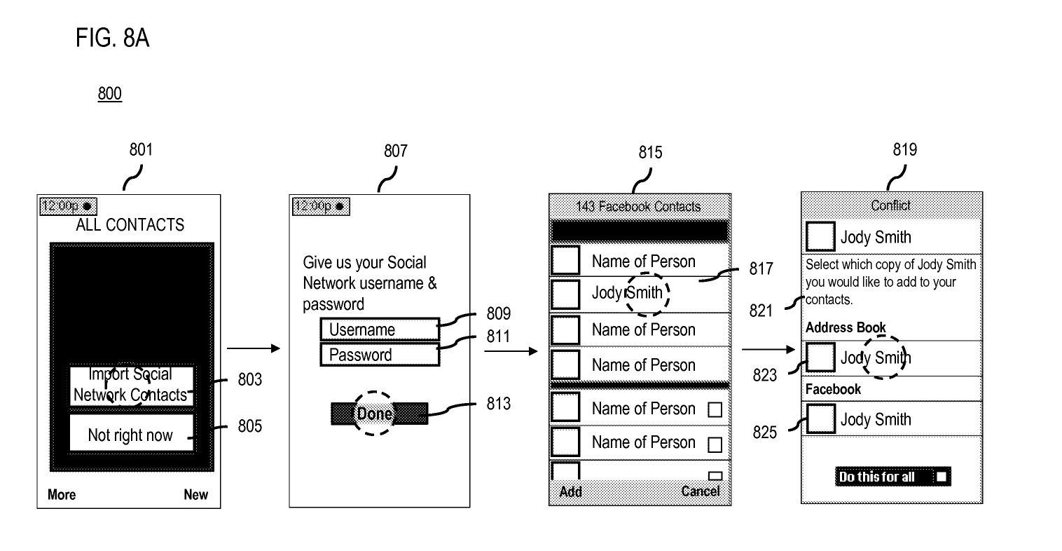

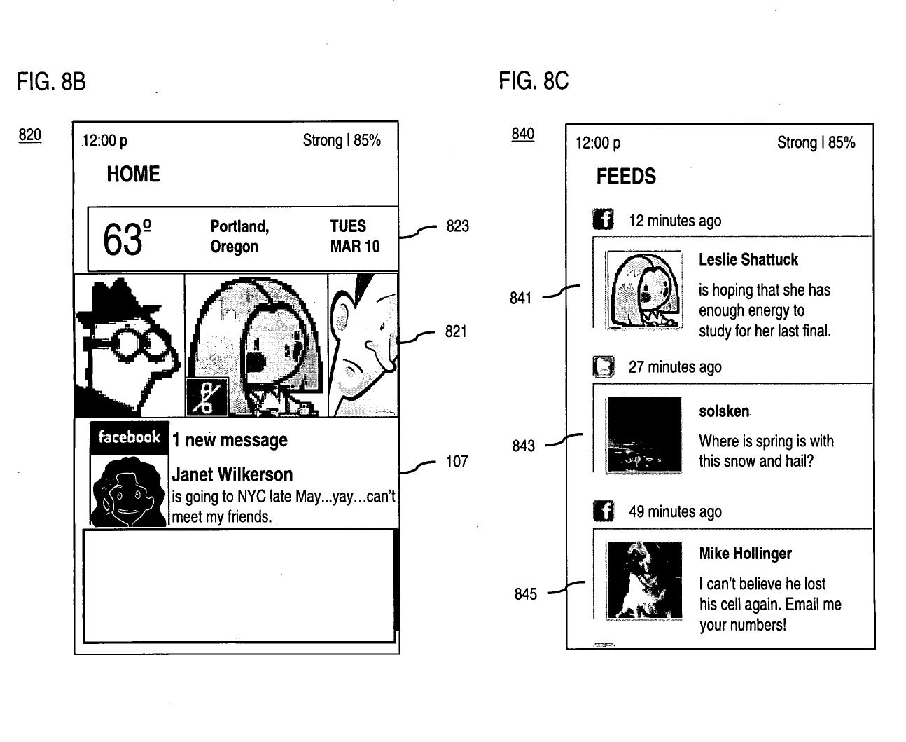

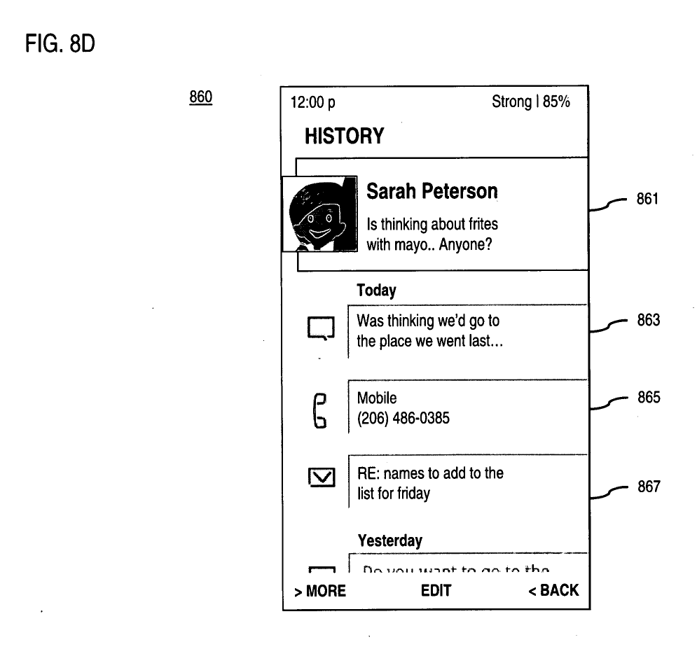

FIGS. 8A-8D are diagrams of user interfaces utilized in the processes for providing social networking content, according to various embodiments. FIG. 8A depicts a user interface 800 for matching the contact list 109 on the mobile device with the members identifiers database 111a from a social networking service 103a (e.g., Facebook®). As shown, a screen 801 is a contact screen providing the option 803 to import social networking (e.g., Facebook®) contacts into the contact list 109 of the mobile device and an option 805 to import the contacts at a later time. In this example, the user selects option 803 to import the contact. In response, the social networking widget 107 displays a screen 807 requesting the user's login credentials to retrieve the contacts from the social networking service 103a. The user then enters a username 809 and a password 811 and selects the “Done” option 813 to complete entry of the login credentials.

On entering the login credentials, the social networking widget 107 retrieves the contacts (e.g., the member identifiers) from the social networking service 103a and matches them against the contact list 109 of the mobile device. The social networking widget 107 then displays a screen 815 presenting a list of matches. The user selects the entry 817 corresponding to “Jody Smith” to view additional information about the matched contact. The social networking widget 107 then displays a screen 819 indicating that a potential conflict exists between the social networking service 103a entry for Jody Smith and the contact list 109 entry for Jody Smith. The screen 819 displays a prompt 821 requesting that the user “Select which copy of Jody Smith you would like to add to your contacts” and provides the option 823 to select the entry from the contact list 109 and the option 825 to select the entry from the social networking service 103a. The user selects the option 823, and the social networking widget 107 keeps the entry from the contact list 109.

FIG. 8B depicts a user interface 820 for presenting extracted social networking content in the social networking widget 107, according to one embodiment. As shown, user interface screen 820 is a home screen for a mobile device (e.g., UE 101) including various widgets (e.g., social networking widget 107, contact widget 821, and weather widget 823. The social networking widget 107 displays extracted content from a social networking service 103a (e.g., Facebook®). In this example, a feed from Jane Wilkerson is displayed within the widget 107 itself.

FIG. 8C depicts a user interface 840 for presenting extracted social networking content chronologically, according to one embodiment. As shown, a user interface screen 840 displays three feeds (e.g., feed 841 from Leslie Shattuck, feed 843 from solsken, feed 845 from Mike Hollinger) arranged in chronological order. In this example, the social networking widget 107 displays the chronological listing of feeds in a separate application screen of the mobile device rather than within the widget 107 as shown in FIG. 8B.

FIG. 8D depicts a user interface 860 for presenting extracted social networking content according to an entry in the contact list 109, according to one embodiment. As shown, a user interface screen 860 displays social networking content that is categorized and presented according to the contact list 109. In this example, the user has selected to display the contact information for a contact “Sarah Peterson.” Accordingly, the social networking widget 107 displays her current feed posting 861 along with a history of other communications linked to the Sarah Peterson. For example, the listing includes a text message 863, a mobile telephone number 865, and an email 867 related to Sarah Peterson.

The processes described herein for providing social networking content may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

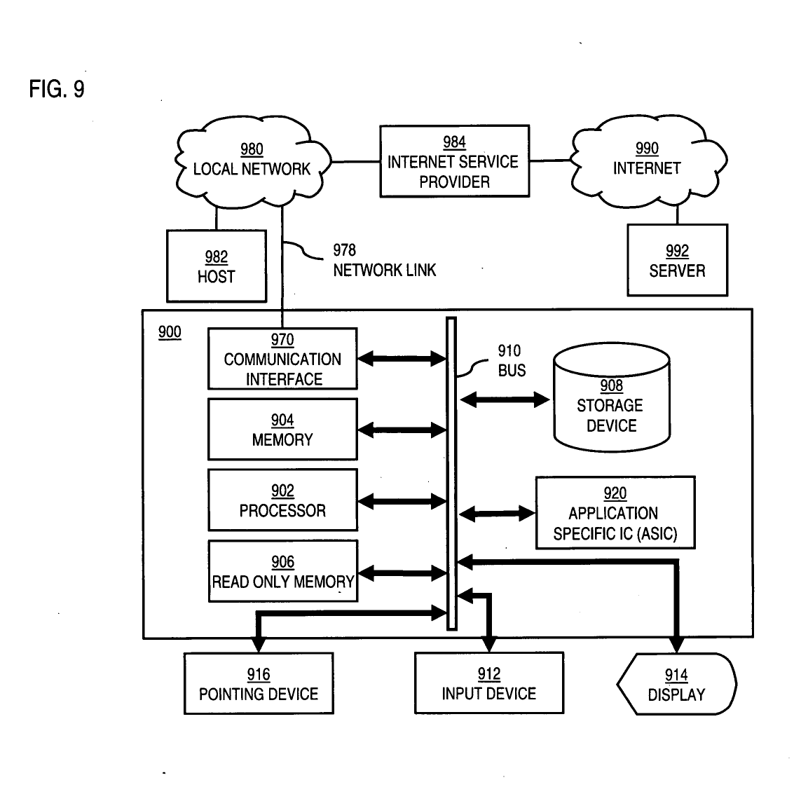

FIG. 9 illustrates a computer system 900 upon which an embodiment of the invention may be implemented. Computer system 900 is programmed to provide social networking content as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 910 includes one or more parallel conductors of information so that information is transferred quickly among devices coupled to the bus 910. One or more processors 902 for processing information are coupled with the bus 910.

A processor 902 performs a set of operations on information related to provide social networking content. The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 900 also includes a memory 904 coupled to bus 910. The memory 904, such as a random access memory (RAM) or other dynamic storage device, stores information including processor instructions for providing social networking content. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for providing social networking content, is provided to the bus 910 for use by the processor from an external input device 912, such as a keyboard containing alphanumeric keys operated by a human user, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT) or a liquid crystal display (LCD), or plasma screen or printer for presenting text or images, and a pointing device 916, such as a mouse or a trackball or cursor direction keys, or motion sensor, for controlling a position of a small cursor image presented on the display 914 and issuing commands associated with graphical elements presented on the display 914. In some embodiments, for example, in embodiments in which the computer system 900 performs all functions automatically without human input, one or more of external input device 912, display device 914 and pointing device 916 is omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of application specific ICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 105 for providing social networking content to the UE 101.

The term computer-readable medium is used herein to refer to any medium that participates in providing information to processor 902, including instructions for execution. Such a medium may take many forms, including, but not limited to, non-volatile media, volatile media and transmission media. Non-volatile media include, for example, optical or magnetic disks, such as storage device 908. Volatile media include, for example, dynamic memory 904. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

FIG. 10 illustrates a chip set 1000 upon which an embodiment of the invention may be implemented. Chip set 1000 is programmed to provide social networking content as described herein and includes, for instance, the processor and memory components described with respect to FIG. 9 incorporated in one or more physical packages. By way of example, a physical package includes an arrangement of one or more materials, components, and/or wires on a structural assembly (e.g., a baseboard) to provide one or more characteristics such as physical strength, conservation of size, and/or limitation of electrical interaction.

In one embodiment, the chip set 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to provide social networking content. The memory 1005 also stores the data associated with or generated by the execution of the inventive steps.

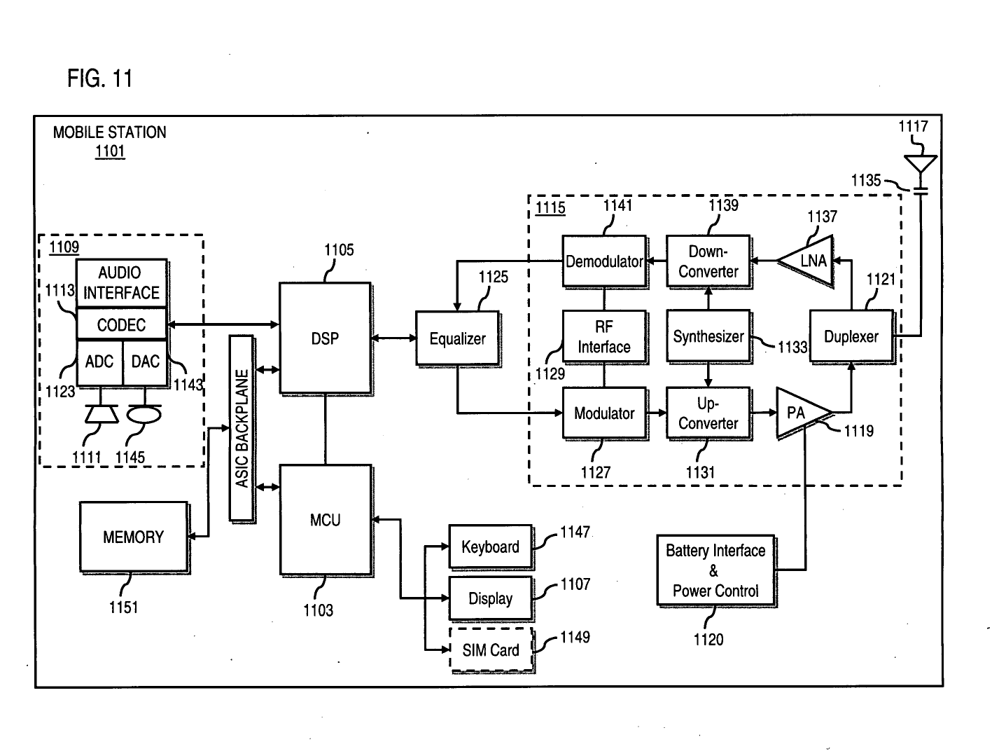

FIG. 11 is a diagram of exemplary components of a mobile station (e.g., handset) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile station functions that offer automatic contact matching. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile station 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103—which can be implemented as a Central Processing Unit (CPU) (not shown).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile station 1101 to provide social networking content. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the station. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile station 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable storage medium known in the art. The memory device 1151 may be, but not limited to, a single memory, CD, DVD, ROM, RAM, EEPROM, optical storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves primarily to identify the mobile station 1101 on a radio network. The card 1149 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising:
generating a request, via a widget of a mobile device, for member identifiers of one or more social networking services;
receiving the requested member identifiers over a radio network;
matching the requested member identifiers with entries of a contact list of the mobile device;
initiating, for a subset of member identifiers that match, prompting of a user of the mobile device to select member identifiers from the subset to follow or to synchronize between the one or more social networking services and the contact list; and
extracting content from the one or more social networking services for the selected member identifiers.

2. A method of claim 1, further comprising:
initiating storing of the extracted content to a database in the mobile device; and
presenting the stored content categorized according to the contact list of the mobile device.

3. A method of claim 1, further comprising:
initiating, for a subset of member identifiers that do not match, prompting of the user to select member identifiers to add to the contact list.

4. A method of claim 23, further comprising:
determining a maximum number of member identifiers based on the bandwidth allocation of the usage plan,
wherein the extracted content is limited based on the maximum number of member identifiers.

5. A method of claim 23, further comprising:
determining a maximum number of features or feeds of the one or more social networking services based on the bandwidth allocation of the usage plan,
wherein the extracted content is limited based on the maximum number features or feeds.

6. A method of claim 23, further comprising:
determining a maximum refresh rate for the content based on the bandwidth allocation of the usage plan,
wherein the extracted content is limited based on the maximum refresh rate.

7. An apparatus comprising:
at least one processor; and
at least one memory including computer program code,
the at least one memory and the computer program code configured to, with the at least one processor, cause an apparatus to perform at least the following,
generate a request, via a widget of a mobile device, for member identifiers of one or more social networking services;
receive the requested member identifiers over a radio network;
match the requested member identifiers with entries of a contact list of the mobile device;
initiate, for a subset of member identifiers that match, prompting of a user of the mobile device to select member identifiers from the subset to follow or to synchronize between the one or more social networking services and the contact list; and
extract content from the one or more social networking services for the selected member identifiers.

8. An apparatus of claim 7, wherein the apparatus is further caused to:
initiate storing of the extracted content relating to the selected member identifiers to a database in the mobile device; and
present the stored content categorized according to the contact list of the mobile device.

9. An apparatus of claim 7, wherein the apparatus is further caused to:
initiate, for a subset of member identifiers that do not match, prompting of the user to select member identifiers to add to the contact list.

10. An apparatus of claim 24, wherein the apparatus is further caused to:
determine a maximum number of member identifiers based on the bandwidth allocation of the usage plan,
wherein the extracted content is limited based on the maximum number of member identifiers.

11. An apparatus of claim 24, wherein the apparatus is further caused to:
determine a maximum number of features or feeds of the one or more social networking services based on the bandwidth allocation wherein the extracted content is limited based on the maximum number of member identifiers,
wherein the extracted content is limited based on the maximum number features or feeds.

12. An apparatus of claim 24, wherein the apparatus is further caused to:
determine a maximum refresh rate for the content based on the bandwidth allocation of the usage plan,
wherein the extracted content is limited based on the maximum refresh rate.

13. An apparatus of claim 7, wherein the apparatus is a mobile phone further comprising:
user interface circuitry and user interface software configured to facilitate user control of at least some functions of the mobile phone through use of a display and configured to respond to user input; and
a display and display circuitry configured to display at least a portion of a user interface of the mobile phone, the display and display circuitry configured to facilitate user control of at least some functions of the mobile phone.

14. An apparatus of claim 13, wherein the mobile phone further comprises a memory configured to store at least a portion of the content from the one or more social networking services.

15-18. (canceled)

19. A method comprising:
receiving input from a mobile device over a radio network for selecting content of one or more social networking services;
determining one or more matching entries between a contact list of a mobile device with member identifiers of the one or more social networking services; and
scaling content associated with the one or more social networking services according to the one or more matching entries.

20. A method of claim 19, further comprising:
initiating update of a contact database corresponding to the mobile device to specify information relating to the selected content and the one or more matching entries.

21. A method of claim 19, wherein the scaling of the content is further based on a usage plan of the mobile device.

22. A method of claim 21, wherein the usage plan specifies a bandwidth allocation.

23. A method of claim 1, wherein the extracting of the content is according to a usage plan of the mobile device, the usage plan specifying a bandwidth allocation.

24. An apparatus of claim 7, wherein the extracting of the content is according to a usage plan of the mobile device, the usage plan specifying a bandwidth allocation.
